(19) United States
(12) Patent Application Publication
(10) Pub. No.: US 2010/0199355 A1
(43) Pub. Date: Aug. 5, 2010

(54) METHOD OF PROTECTING DIGITAL DOCUMENTS AGAINST UNAUTHORIZED USES

(75) Inventors: Mohamed Amine Ouddan, Fontenay Sous Bois (FR); Hassane Essafi, Orsay (FR)

Correspondence Address: WEINGARTEN, SCHURGIN, GAGNEBIN & LEBOVICI LLP, TEN POST OFFICE SQUARE, BOSTON, MA, 02109, US

(73) Assignee: ADVESTIGO, Saint Cloud (FR)

(21) Appl. No.: 12/532,754

(22) PCT Filed: Mar. 21, 2008
(86) PCT No.: PCT/FR08/50503

§ 371 Date: Mar. 22, 2010

(30) Foreign Application Priority Data
Mar. 23, 2007 (FR) 0702152

(51) Int. Cl. G06F 21/00

(52) U.S. Cl. 726/26

(57) ABSTRACT

The method comprises: taking a digital document for protection that constitutes a piece of source code, and identifying therein a programming language L defined by a grammar G_{L}; associating an action grammar module with said programming language L; performing a structural characterization of the code in a single syntactic analysis pass on the basis of the action grammar module; this being done by constructing a grammar dictionary GD_{L} associated with the programming language and comprising a set of structural terms such that each of these terms is associated with a rule or a set of rules belonging to said grammar (G_{L}) and by transforming the source code into a structural sequence (R_{L}, T_{L}, GD_{L}) comprising the set of structural terms and the dictionary GD_{L} of the grammar of the language L; proceeding in the same manner to transform a digital document for analysis into a structural sequence (R_{L}, T_{L}, GD_{L}); and measuring the plagiarism ratio between the source code of the digital document for protection and the source code of the digital document for analysis with the help of quantification of the alignment ratio between the respective structural sequences of the source code of the digital document for protection and the digital document for analysis.

### FIELD OF THE INVENTION

The present invention relates to a method of protecting digital documents against unauthorized uses.

In a world dominated by information technology, software plays a major role in the property of a business and is considered as the backbone of its activity. Software often encapsulates the know-how and the intellectual property of a business. Thus, software created by a business represents a very considerable asset and net worth for the business. In spite of the magnitude of this asset it is often the subject of little or poor protection.

It is essential for a business to ensure that its software is not “totally” or “partially” disseminated without its agreement. This is to avoid risk both to the factor that distinguishes the business (from the competition) and to its added value for its customers.

Unfortunately, at present there do not yet exist any technical means that enable such businesses to be warned of any attempt at unlawful dissemination of their software.

### PRIOR ART

When a piece of software is suspected as being potentially a copy of some other software, the original software and the suspect software are often compared by a human expert employed to determine how much piracy has taken place. This investigation is carried out on basic elements making up a piece of software, such as the architecture of its programs, the documentation associated with the software, and the object code that results from compiling its source code. Investigations are carried out most often on source code.

Source code documents are structured in application of a precise grammar in which each line plays a role in the result of executing the program associated therewith, and consequently it conveys several sources of information.

Proposals have already been made to transform the content of source code written in a high level programming language into code written in a language having a lower level of abstraction than that of the source language, while still preserving the meaning of the code.

There are three fields of application where access to source code via its content is a necessary step. The first field is revising software, since the ongoing development thereof requires continuous maintenance of the source code. Code duplication is the main problem encountered during maintenance, and the quantity of code that is duplicated generally lies in the range 5% to 10% and may be as much as 50%. It is found to be necessary to develop tools for detecting duplicated code in order to facilitate the operations of revising software for new functionalities, if any.

The second field is identifying the author of a program on the basis of a set of metrics characterizing the programming style that may be contained in the source code. Among applications that can benefit from such identification, mention can be made of legal and university settings, in particular when claiming copyright, industrial settings, and more precisely systems for monitoring security in real time. The main task of systems of that kind consists in detecting intrusions of programming style that is different from the styles of local programmers.

The third field is detecting cases of code plagiarism. Parker and Hamblen define plagiarism of source code as being a reproduction of code from existing code with changes that are few in number.

The development of the Internet and of search engines such as Google are two major factors that make it easier to obtain source code, thus encouraging the appearance and the multiplication of open-source software, and consequently, free access to source code makes software plagiarism possible without complying with the associated licenses.

The methods and approaches that enable the content of source code to be represented need to conserve as much as possible of the information conveyed by the code. Unlike text documents in natural languages, the content of source code documents can be projected into different representation spaces. This difference lies in the fact of using a variety of approaches, such as statistical, conceptual, or structural approaches. The features of source code present a wide range of models enabling its content to be characterized.

Two main approaches emerge from this variety of models: approaches based on purely statistical information, and approaches based on structural information.

The principle of methods based on the vector model relies on calculating a set of metrics that singularize each piece of source code. All pieces of code can thus be characterized by a vector of m values and represented in a space of m dimensions. The set of these vectors is used by a shape recognition system that consists in calculating statistical distances and in measuring correlations between these characteristic vectors. In a large database, where the set of these pieces of code is represented by a cloud of points in vector space, the use of different methods of classification and clustering is found to be essential in order to perform a search that is fast and pertinent.

Furthermore, the characteristic vectors need to be normalized so as to achieve clustering and comparison that is uniform, in which all of the metrics making up the vectors make a contribution. Mention can be made of certain metrics that have been used in prior work:
code complexity: this complexity is reflected by a set of metrics defined by Halstead. Those metrics represent quantitative measurements of the operators and operands that make up the source code;
the complexity measurement proposed in 1976 by Thomas J. McCabe. That measurement is known under the name of cyclomatic complexity and is based on the cyclomatic number of graph theory. It characterizes the connectivity between code elements, as represented by a graph representative of the behavior of the program associated with the code; and
the metrics used by Faidhi and Robinson when characterizing Pascal programs, such as the total number of characters per line, the mean lengths of functions and of procedures, the percentage of iterative blocks, the total number of expressions, etc.

Other metrics may be added or combined with one another in order to characterize source code better.

In the approach based on structural models, the object is to exploit the structural properties of the source code. The two main models for representing structural information are conceptual graphs and graphs of data dependencies and flow control.

The tools based on the vector model do not provide sufficient performance to be robust against the various techniques used in plagiarism. Characteristic vectors can be altered merely by adding a few instructions to the plagiarized code. Another drawback of that type of model is due to the fact that two pieces of code having vectors that are close, but of semantic content that is different, will be considered as constituting an instance of plagiarism. That drawback can be explained by the absence of structural and semantic information in representations based on the vector model.

In contrast, plagiarism-detection tools based on structural approaches are less sensitive to the changes that plagiarized code might suffer. However the difficulty lies in using complex structures for representing source code and in finding techniques that are capable of quantifying similarity between such structures. This considerably increases costs in terms of computation, in particular for approaches that are based on trees and on graphs.

The conceptual graph model proposed by John Sowa is a model representing knowledge in which each graph is a labeled bipartite graph made up of two types of vertex: vertices labeled with concept names (representing entities, attributes, states, and events), and vertices labeled with the names of conceptual relationships that define the links between concepts. Gilad Mishne and Maarten de Rijke use conceptual graphs for representing the structural content of a piece of code, where concepts are represented by the blocks of instructions and the operations that are permitted by the language, while relationships are represented by the structural links that may exist between concepts.

Dependency and flow control graphs serve to analyze and study the trace of a program associated with a piece of code. The trace is considered as being an information series that reflects how the state of the program varies while it is executing. In research work relating to dependency and flow control graphs, mention can be made of the work by Pfeiffer in which he proposes algorithms that characterize and estimate the dependencies of a piece of code in order to study and analyze the behavior of the program that is associated therewith.

Dependency graphs are constructed from analyses based on breaking down the source code into control structures such as iterative blocks, conditional blocks, or blocks of simple instructions. Thus, the structure of a dependency graph describes the order in which individual instructions are to be executed by the process associated with a piece of code.

Based on the syntactic analysis of the piece of code, a data flow control graph is a graph that is oriented and labeled. The nodes of that type of graph are constituted by basic elements of the code, and the arcs interconnecting the nodes are labeled depending on the natures of the data flows that exist between the nodes.

Various techniques exist for transforming source code that are often used during plagiarism operations. Those techniques serve to distinguish the content of plagiarized code from the content of original code while conserving the same original functionalities. Plagiarism detection tools need to be robust in the face of these transformations in order to be better at detecting cases of plagiarism.

The difficulty of the detection task depends on the complexity of the modifications made to the original code. These transformations vary from the most simple to the most complex, from mere cutting-and-pasting to rewriting certain portions of the code. Two types of transformation may be distinguished:

A) Transformations of the first type are of a lexical nature. These transformations include:
giving new names to the identifiers (variables, functions): identifiers having meaningful names are replaced by names that are randomly generated, as shown in Table 1 below;
substituting constant character strings by code strings (ASCII code, Unicode, etc.) so that content is conserved; and
modifying comments: one of the transformations that can be applied to an original piece of code is to eliminate all comments from the code (or to insert new comments). In other cases they are modified manually while preserving the same meaning as in the original.

B) Transformations of the second type are structural in nature, requiring knowledge of the language and depending strongly on the grammar that defines it. Amongst such structural transformations, those that are used the most frequently include the following:
changing the order of blocks of instructions, in such a way that the behavior of the program is unaffected;
rewriting expressions (making permutations between operands and operators);
changing the types of variables;
adding redundant instructions, instruction blocks, or variables, providing the behavior of the program is not altered;
control flow degeneracy, as shown in Table 2 below;
substituting iterative or conditional control structures with other control structures that are equivalent. For example, an iterative block of the “While” type can be transformed into an iterative block of the “For” type; and
substituting calls to functions with the bodies of those functions.

These transformations may be grouped together as a function of their levels of complexity, as specified in the work of Faidhi and Robinson where they are represented by a spectrum of six levels. From level 1 to level 3 the transformations are of a lexical nature, from level 4 to level 5 the transformations relate to structure and control flow, whereas level 6 combines all possible transformations of a semantic nature such as rewriting expressions.

The characterizations obtained by the approaches based on vector models and also those based on structural models are effective only in processing transformations of levels 1 to 3.

TABLE 1

| Original code | Transformed code |
|---|---|
| 1 #ifndef PI_H | 1 #ifndef 11010 |
| 2 #define PI_H | 2 #define 11010 |
| 3 #ifndef PI | 3 #ifndef 11 |
| 4 #define PI(4*atan(1)) | 4 #define 11(4*atan(1)) |
| 5 #endif | 5 #endif |
| 6 #define deg2rad(d) d*PI/180 | 6 #define O1(110) 110*11/180 |
| 7 #define rad2deg(r) r*180/PI | 7 #define O0(111) 111*180/11 |
| 8 #endif /* PI_H */ | 8 #endif /* 11010 */ |

TABLE 2

| Original code | Transformed code | |
|---|---|---|
| 1 int main( ){ | 1 | int main( ){ |
| 2 float x=−2.0,y=1.2,z; | 2 | float x=−2.0,y=1.2,z; |
| 3 z=fabs(x); | | int br=1; |
| 4 y++; | | intit: |
| 5 x+=y; | | switch(br){ |
| 6 z=x+y; | | case 1: |
| 7 printf(“%f,%f,%f”,x,y,z); | 3 | z=fabs(x); |
| 8 return 0; | 4 | y++; |
| 9 } | | br=2; |
| | | goto init; |
| | | case 2: |
| | 5 | x+=y; |
| | 6 | z=x+y; |
| | 7 | printf(“%f,%f,%f”,x,y,z); |
| | | } |
| | 8 | return 0; |
| | 9 | } |

### OBJECT AND BRIEF SUMMARY OF THE INVENTION

The invention seeks to remedy the above-mentioned drawbacks and makes it possible to characterize source code in such a manner that it is subsequently possible to detect different varieties of plagiarism in automatic manner.

In accordance with the invention, these objects are achieved by a method of protecting digital documents against unauthorized uses, the method being characterized by: taking a digital document for protection that constitutes a piece of source code, and identifying therein a programming language L defined by a grammar G_{L}; associating an action grammar module with said programming language L, such that:

a) the grammar G_{L} is constituted by a set of rules written R={R₁, R₂, . . . , Rₙ}; and

b) the action grammar module is constituted by a set of actions written AC={S₁, S₂, . . . , Sₘ}, such that:
Sᵢ={action₁, action₂, . . . }∀i=1, . . . , m is the set of actions associated with the rule Rᵢ; and
m≦n;
   performing a structural characterization of the code in a single syntactic analysis pass on the basis of the action grammar module; this being done by constructing a grammar dictionary GD_{L} associated with the programming language and comprising a set of structural terms such that each of these terms is associated with a rule or a set of rules belonging to said grammar G_{L} and by transforming the source code into a structural sequence (R_{L}, T_{L}, GD_{L}) comprising the set of structural terms and the dictionary GD_{L} of the grammar of the language L; proceeding in the same manner to transform a digital document for analysis into a structural sequence (R_{L}, T_{L}, GD_{L}); and measuring the plagiarism ratio between the source code of the digital document for protection and the source code of the digital document for analysis with the help of quantification of the alignment ratio between the respective structural sequences of the source code of the digital document for protection and the digital document for analysis.

The three main components that distinguish programming languages from other languages are: declarations; instructions; and expressions. These components are considered as being “Critical Points” in a piece of source code, whence the need to make use of the information contained at this level of the code.

Declarations may be of the data, variables, functions, or predicates type. A wide variety of expressions are permissible in programming, such as relational, logical, arithmetic, and other expressions, which are specific to each language (for example expressions of the “Cast” type in C/C++). The third component may be of an atomic nature such as input/output instructions, or of a composite nature such as iterative blocks.

These Critical Points are represented in the code by a set of lines that, if deleted, can give rise to changes in the behavior (or the result) of the program generated by the code. It can be observed that at the above-mentioned Critical Points there are two sources of information and that these are common to all programming languages:
The first source emerges from an analysis of the data flow existing between the Independent Segments of the code. The term “Independent Segment” is used herein to mean a block of instructions that can be used separately in another context. Two analysis variants occur, intra-procedural analysis that applies to flows between individual entities of an Independent Segment, and inter-procedural analysis that takes into consideration the flow inherent to communications between such Independent Segments. On the basis of an analysis of the various data flows, structural properties of a piece of source code can be deduced. These properties enable the information conveyed by the individual entities of a piece of source code to be characterized regardless of the language used. For imperative languages, the individual elements of an Independent Segment may be variables, functions, function parameters, objects, etc. For functional languages they represent functions and expressions, and finally for logical languages they represent predicates, symbols, and all of the relationships permitted by that type of language.
The second source of information emerges from a feature that is common to all programming languages. This feature is represented by the regular aspect both of the lexicon and of the syntax of programming languages enabling well-formed code to be characterized. Nevertheless, each programming language possesses its own features, implying a specific grammar. Starting from these grammars, it is possible to perform structural characterization based on the concept of a “Grammar Dictionary” regardless of the programming language model (imperative, functional, or logical). To do this, it is necessary to introduce the concept of an “Action Grammar” as put into concrete form by a module that is described in greater detail below.

A grammar of a language makes it possible to perform lexical and syntactic analysis of the code in order to verify whether the code does indeed comply with the syntax of the language. This analysis is performed without interpreting the code. As a result, in order to access the structural content of a piece of code, the grammar must enable this code to be translated from the programming language to the characterization language. Thus, the grammar needs to be harmonized with a set of so-called “characterization” actions, whence the term “Action Grammar”. The logic of this concept consists in giving a meaning to the syntactic analysis of the source code and it may thus incorporate an interpretation and a traceability of the analysis in a characterization context.

The basic idea is thus summed up in associating each grammar rule with a set of actions. These actions contribute to constructing characteristic structures that are referred to as “Structural Sequences”, as shown in FIG. 1. Each term or series of terms belonging to these sequences must reflect a discriminating structural concept, thus enabling a piece of code to be singularized during structural characterization thereof.

The two main features of programming languages are the regular appearance of the syntax and the concept of data flow. These two features make it possible to establish correspondence between the structural content of the code and its characteristic structure.

Thus, each programming language L defined by a grammar written G_{L} can be associated with an Action Grammar module such that:

1) The grammar G_{L} is constituted by a set of rules written R={R₁, R₂, . . . , Rₙ}.

2) The Action Grammar module is constituted by a set of actions written AC={S₁, S₂, . . . , Sₘ}, such that:
Sᵢ={action₁, action₂, . . . }∀=1, . . . , m is the set of actions associated with the rule Rᵢ;
m≦n.

The sequential nature of the characteristic structures emerges from the conceptual and functional similarities that exist between a compiler and the Action Grammar module. By definition, a compiler enables source code to be translated into another code written in machine language. This language is generally sequential in nature and it is represented by a succession of instructions. In the same way, it is possible for an Action Grammar module to be able to translate the content of a piece of code into a sequence of characteristic symbols regardless of the model of the source language.

It should be observed that the main advantage of the Action Grammar module is the fact of being able to perform structural characterization of a piece of code in a single syntactic analysis pass.

This structural characterization consists in calculating a trace of the syntactic analysis of the piece of code. This trace is defined by a subset of grammar rules reflecting the way in which the code is analyzed syntactically. The subset thus contains the grammar rules that were used during the syntactic analysis, during which the characterization actions that are associated with these rules are executed. These actions consist in inserting characteristic terms in the “Structural Sequence”, thereby reflecting the structural concepts contained in each of the rules. For example, an “iterative block” and a “stop condition” are two concepts that emerge from three grammar rules that define control structures of the respective types: “While”; “For”; and “Do”. Whence the need to associate these three rules with the same characterization actions and the same Structural Terms that express these two concepts.

As a result, a Grammar Dictionary can be constructed that is associated with each programming language. Such a dictionary is constituted by a set of terms referred to as “Structural Terms”, such that each of these terms is associated with a rule or a set of rules. For each language L defined by a grammar G_{L} constituted by a set of rules written R, there is an associated grammar dictionary GD_{L} establishing correspondences between the rules and the terms:

GD_{L}: R→set of Structural Terms
Rᵢ→tᵢ

Characterizing the lexical and the syntactic appearance of the code makes it possible to extract a topology for the content thereof. This topology reflects the structural links that may exist between the various concepts that emerge from one or more grammar rules such as functions, lists of arguments, blocks of atomic instructions, etc. This characterization must be robust in the face of the alterations that a piece of plagiarized code may contain compared with the original code, whence the need to associate the grammar rules with the Structural Terms in a pertinent manner.

The structural characterization of a piece of code written in a language L may be considered as a deterministic, finite automaton and may be defined by the following triplet (R_{L}, T_{L}, GD_{L}) where:

R_{L}: is the set of rules in the grammar G_{L};

T_{L}: is the set of Structural Terms; and

GD_{L}: is the Grammar Dictionary of the language L that enables the trace of the syntactic analysis of the code to be calculated, thus making it possible to feed the Structural Sequence progressively as the grammar rules are used during analysis.

After presenting the characterization approach that consists in transforming a piece of source code into a set of Structural Sequences, a second stage is implemented that enables a plagiarization ratio between two pieces of code to be measured. This may be performed by quantifying an alignment ratio between the respective Structural Sequences.

The measure of similarity between two sequences, considered as being an abstraction of the plagiarism ratio, needs to be robust in the face of the transformations that may be contained in a plagiarized version of the code, such as permutations and duplications of code segments, insertions and deletions of lines of code, etc.

In order to have a measurement that is representative of the similarity between two pieces of source code, and in a manner that is as pertinent as possible, three main constraints are defined that must be satisfied while measuring the plagiarism ratio.

1) Common sub-sequences must be detected without taking account of their respective positions in each of the two Structural Sequences. In other words, plagiarism detection must be insensitive to permutations between blocks of instructions.

2) The longest sub-sequences must contribute most in calculating the plagiarism ratio, while at the same time sub-sequences that are embedded in long sequences must not be omitted. This constraint is due to the fact that long sub-sequences are more reliable and more pertinent, whereas short sub-sequences are often a source of noise and lead to false detections of plagiarism.

3) Avoiding redundancy and overlap between common sub-sequences, i.e. when independent segments of an original piece of code have been distributed redundantly in the plagiarized code, it is necessary to avoid such redundancy appearing in the set of common sub-sequences, which would cause the plagiarism ratio to be increased unduly, and vice versa, i.e. when the redundant segments are not plagiarized, that would lower the plagiarism ratio.

A sequence comparison based on the technique involving the use of a matrix of points and known as a “dot plot” is found to be the most appropriate for satisfying these three constraints. This technique is highly informative from a visual point of view.

A dot plot thus provides a visual representation of the alignment between two Structural Sequences. These two sequences are placed along the axes of a two-dimensional graph, with each point (i,j) representing similarity between the i^{th} term and the j^{th} term in the two sequences.

### BRIEF DESCRIPTION OF THE DRAWINGS

Other characteristics and advantages of the invention appear from the following description of particular embodiments, given as examples, and with reference to the accompanying drawings, in which:

FIG. 1 is a block diagram showing diagrammatically the structure of an action grammar module used in the context of the present invention;

FIG. 2 is a diagram showing the measure of similarity between two structural sequences A and B, in a step of the method of the invention;

FIG. 3 plots two curves representing the frequency of appearance of structural terms in characteristic sequences of two Java codebases; and

FIG. 4 shows the various levels in the spectrum of techniques for plagiarizing a piece of source code.

### DETAILED DESCRIPTION OF PARTICULAR IMPLEMENTATIONS OF THE INVENTION

In order to be able to monitor the dissemination of software, the present invention provides particular characterization of the content of source code documents for the purpose of measuring the similarity between the content of a digital document for protection and the content of a digital document for analysis, thus making it possible to detect the existence of a case of plagiarism.

Characterizing the content of source code documents is a task that is very complex because of the similarity that exists between the various pieces of source code for computer projects. In addition, there are numerous plagiarism techniques that can be used to make plagiarism difficult to detect. The present invention proposes an approach to characterization based on a Grammar Dictionary and on the concept of an Action Grammar. These two concepts are made concrete by a module giving access to the structural content of the code by means of the grammar of the language in which the code is written. The actions of the module consist in translating a piece of code in the source language to a characterization language in which the code is represented by a characteristic sequence. A sequence alignment technique is then applied to measure the similarity ratio between two characteristic sequences with two different pieces of code. This ratio is considered as being an abstraction of the plagiarism ratio detected between the two pieces of code in question.

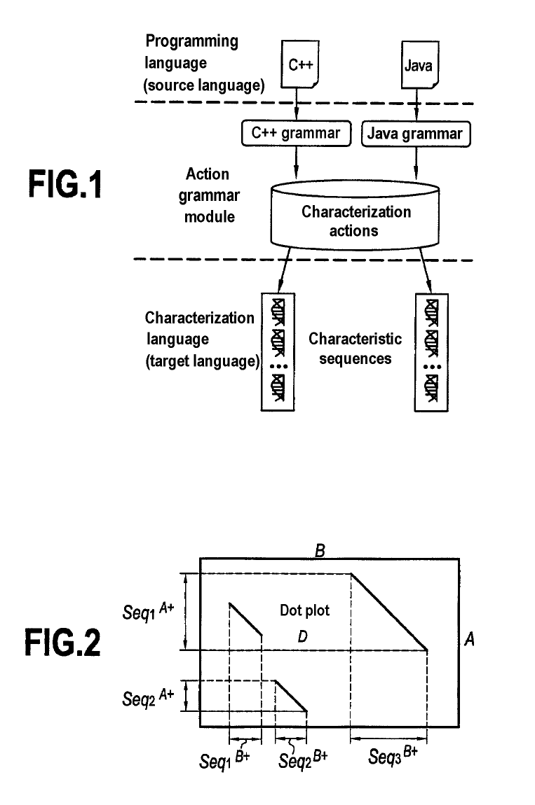

As can be seen in FIG. 1, which symbolizes an action grammar module, for each programming language constituting a source language, such as C++ or Java, for example, a grammar is drawn up that comprises a set of rules.

Each grammar is harmonized with a set of so-called “characterization” actions. These actions contribute to constructing characteristic structures that are referred to as “Structural Sequences”. A characterization language or target language is then defined from the characteristic sequences and that takes the place of the programming language or source language for the purpose of measuring the plagiarism ratio between two pieces of source code by quantifying the alignment ratio between the respective Structural Sequences.

As mentioned above, it is possible to compare sequences on the basis of the dot plot technique.

A dot plot thus provides a visual representation of the alignment between two Structural Sequences. These two sequences are placed along the axes of a two-dimensional graph, with each point (i,j) representing similarity between the i^{th} term and the j^{th} term in the two sequences.

Thus, a matrix of points serving to measure the similarity ratio between two Structural Sequences A and B is defined by equation (3). The sequences A and B are respectively defined by equations (1) and (2):

A=<a₁,a₂, . . . , aₙ> (1)

B=<b₁,b₂, . . . , bₘ> (2)

D=(dᵢⱼ)/i=1 . . . n,j=1 . . . m

Such that:

$${d}_{ij} = \{ \begin{matrix}1 & if {a}_{i} = {b}_{j} \\ 0 & if otherwise\end{matrix} \qquad ( 3 )$$

Two metrics are defined that are calculated from the dot plot, serving to quantify zones of similarity and thus making it possible to calculate the plagiarism ratio between two pieces of code. These two metrics provide information about the lengths of all common sub-sequences between two Structural Sequences, and simultaneously about the modifications made to the original version of the code. For example, a discontinuous diagonal represents an exact copy with modifications, a redundant copy of a code segment gives rise to parallel diagonals, etc.

The two metrics are represented by two estimator vectors “VM_{H}, VM_{V}” that are calculated from horizontal and vertical projections of elements of the metrics D_{n,m}. The two vectors are defined respectively by equations (4) and (5):

VM_{H}(n)=vmᵢ

### With:

$${vm}_{i} = {\sum }_{j = 1}^{m} {d}_{ij} \\ {VM}_{V} ( m ) = {vm}_{i} \qquad ( 4 )$$

### With:

$${vm}_{i} = {\sum }_{j = 1}^{m} {d}_{ji} \qquad ( 5 )$$

Successive non-zero elements in each of the two estimator vectors represent sub-sequences that match between the two Structural Sequences A and B, and referred to as positive sub-sequences, written Seq^{A+}, Seq^{B+}. These common sub-sequences represent structural concepts that are similar in the two pieces of source code characterized by the sequences A and B.

Thus, the measure of similarity between the sequences A and B, written Sim(A,B) is defined by equation (6):

$$Sim ( A , B ) = max ( \frac{{\sum }_{i} \vert {Seq}_{i}^{A +} \vert}{\vert {Seq}^{A} \vert} , \frac{{\sum }_{i} \vert {Seq}_{i}^{B +} \vert}{\vert {Seq}^{B} \vert} ) \qquad ( 6 )$$

### With:

Seqᵢ^{A+} being the i^{th} positive sub-sequence extracted from the vector VM_{H} and Seqᵢ^{B+} being the i^{th} positive sub-sequence extracted from the vector VM_{V}.

FIG. 2 summarizes similarity measurements between the two Structural Sequences A and B:

There follows an analysis and a synthesis of the characterization approach of the invention, with mention of the advantages it brings to the problem of source code plagiarism. Thereafter the robustness of the Structural Sequences against the various transformation techniques commonly used during plagiarism operations is evaluated.

Translating a piece of source code in an original language into a different language is also used as a plagiarism technique. In most cases, the language of the plagiarism is of the same type as the original language, for example code written in Java can be plagiarized by being translated into code written in C++, or code written in Pascal can be plagiarized by other code written in C. As a result, it is important to characterize in identical manner two pieces of code that are written in different languages in order to counter cases of plagiarism that use the technique of translation.

The modular architecture of the system of the invention, and in particular that of the Action Grammar module provides the possibility of performing multi-language characterization. By using the corresponding grammars, two similar pieces of code written in different languages can be represented in the same sequence space.

Let there be two programming languages L1 and L2 defined respectively the triplets (R_{L1}, T_{L1}, GD_{L1}) and (R_{L2}, T_{L2}, GD_{L2}). Two Action Grammar modules associated with L1 and L2 will produce similar Structural Sequences for two pieces of code C_{L1} and C_{L2} written in the L1 and L2 languages, providing these the two languages are of the same type, i.e. providing there exists a subset of Structural Terms common to both languages (equation (7)).

GD_{L1}∩GD_{L2}≠{Ø} (7)

A characterization approach based on the grammar of the language and independent of the textual representation of the code serves to reinforce the pertinence of Structural Sequences relative to the structure of the code and in particular the syntax of the language.

In order to characterize similar control structures in the same manner, each Structural Term needs to be associated with the set of grammar rules that reflect the same concept. By way of example, mention can be made of iterative blocks of the “For”, “While”, and “Do” types that are represented by the same Structural Term. The fact of associating the same Structural Term to control operations of the same type provides greater robustness and pertinence in the Structural Sequences, in particular for countering transformation techniques that consist in replacing control structures by others that are similar thereto.

The construction of the Grammar Dictionary is an important step in structural characterization, in particular for optimizing the costs of computing the Structural Sequences, in terms of execution time and memory utilization.

In this perspective, it is necessary to study the grammar rules of the language so that the Grammar Dictionary associated with the language contains only those rules that contribute most to characterizing code, i.e. the rules with the greatest discriminating power. This makes it possible to reduce the size of the Grammar Dictionary, and hence the complexity of the Structural Sequences.

By way of example, a structural characterization has been carried out on two Java code bases. The first base represents the source of JDK 1.4.0, and the second base is constituted by a set of pieces of code developed in specific manner.

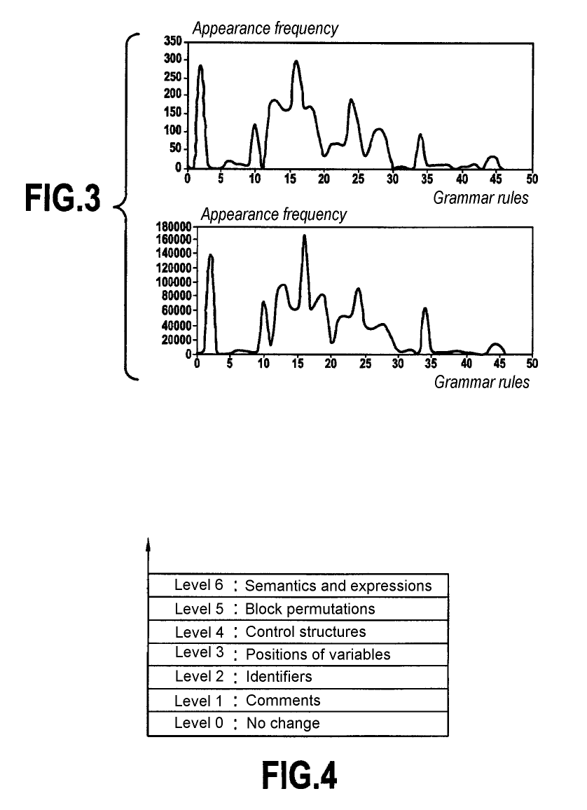

The curves of FIG. 3 plot the frequencies with which Structural Terms appear in the characteristic sequences of the two bases. In both bases, it can be seen that the most frequent and most redundant terms appear in the Structural Sequences of the majority of the pieces of code belonging to both bases, and it can also be seen that both curves have the same appearance.

The terms having the highest frequencies correspond to the grammar rules described initializing a variable, blocks for managing “Try . . . . Catch” exceptions, and function definitions. As a result, it is advantageous to make use only of a subset of Structural Terms, containing only terms that are frequent (i.e. that are associated with the grammar rules that are used the most during syntactic analysis), and consequently it is possible to optimize the cost of sequence alignment operations because there will be less redundancy in the Structural Sequences.

There follows an evaluation of the robustness of Structural Sequences in the face of various plagiarism techniques that attempt to make code unreadable and to make it different from the original. These techniques have been classified in six levels by Faidhi and Robinson, as shown in FIG. 4:

By way of example, a piece of code written in Java (code for traversing a binary tree) was modified in application of the six levels defined in FIG. 4. Thereafter the plagiarism ratio was calculated between the modified pieces of code corresponding to each level and the original version of the same piece of code. The modifications made to the original code were as follows:
level 0: no modification;
level 1: modification to comments, adding new comments, deleting comments, and modifying character strings in output messages;
level 2: changing variable names (nine variables) plus the changes of level 1:
level 3: changing declarations and their positions in the code (replacing two constants by two new declared variables, changing the positions of declarations amongst three variables) plus the changes of level 2;
level 4: replacing two “For” iterative blocks by two “While” blocks, and one “While” iterative block by a “For” block plus the changes of level 3;
level 5: changing modularity (creating two new functions, changing positions between two existing functions) plus the changes of level 4; and
level 6: changing two logic expressions and permutating the content of an “If” and “Else” block by modifying the expression evaluated in the “If” test, plus the changes of level 5.

The results of calculating the plagiarism ratios between the original code and the modified versions are illustrated below. For each transformation level, an alignment ratio was calculated in the Structural Sequences thus representing the plagiarism ratio between two pieces of code (the original and the transformed code).

It was found that the plagiarism ratio calculated from the Structural Sequences was of the order of 100% for levels 0, 1, and 2 and remained large at the higher levels (about 70% for level 3 and 60% for level 4).

The method of characterizing source code type documents and based on the concept of a “Grammar Dictionary” enables the lexical and syntactic information in a piece of source code to be characterized by Sequential Structures. These structures conserve the structural information conveyed by the code even if the code has been subjected to several levels of transformation. Another feature of the method lies in the fact that it is possible to perform multi-language characterization, thus making it possible to detect code that has been plagiarized and translated into other languages. The Structural Sequences are quite robust against the transformation techniques that are commonly used during plagiarism operations.

The dot plot approach provides robustness in the detection of plagiarism.

1. A method of protecting digital documents against unauthorized uses, the method being characterized by:
taking a digital document for protection that constitutes a piece of source code, and identifying therein a programming language L defined by a grammar G_{L};
associating an action grammar module with said programming language L, such that:
a) the grammar G_{L} is constituted by a set of rules written R={R₁, R₂, . . . , Rₙ}; and
b) the action grammar module is constituted by a set of actions written AC={Sᵢ, S₂, . . . , Sₘ}, such that:
Sᵢ={action₁, action₂, . . . }∀i=1, . . . , m is the set of actions associated with the rule Rᵢ; and
m≦n;
performing a structural characterization of the code in a single syntactic analysis pass on the basis of the action grammar module;
this being done by constructing a grammar dictionary GD_{L} associated with the programming language and comprising a set of structural terms such that each of these terms is associated with a rule or a set of rules belonging to said grammar (G_{L}) and by transforming the source code into a structural sequence (R_{L}, T_{L}, GD_{L}) comprising the set of structural terms and the dictionary GD_{L} of the grammar of the language L;
proceeding in the same manner to transform a digital document for analysis into a structural sequence (R_{L}, T_{L}, GD_{L}); and
measuring the plagiarism ratio between the source code of the digital document for protection and the source code of the digital document for analysis with the help of quantification of the alignment ratio between the respective structural sequences of the source code of the digital document for protection and the digital document for analysis.
